(19) United States
(12) Patent Application Publication
(10) Pub. No.: US 2009/0148365 A1
(43) Pub. Date: Jun. 11, 2009

(54) Recovery of Solid Magnesium Sulfate Hydrate

(76) Inventors: Eric Girvan Roche, Booragul (AU); Jacqueline Whitehead, Birmingham Gardens (AU)

Correspondence Address: BRINKS HOFER GILSON & LIONE, P.O. BOX 10395, CHICAGO, IL, 60610, US

(21) Appl. No.: 12/142,300

(22) Filed: Jun. 19, 2008

Related U.S. Application Data
(63) Continuation of application No. PCT/AU2006/001984, filed on Jun. 28, 2007.

(30) Foreign Application Priority Data
Dec. 22, 2005 (AU) 2005907249

(51) Int. Cl. C01F 5/00; C01F 5/40

(52) U.S. Cl. 423/164

(57) ABSTRACT

A process for recovering solid magnesium sulfate hydrate from a source of magnesium sulfate in solution includes the steps of providing a source of magnesium sulfate in solution that is derived from part of a process associated with the leaching of a metal containing ore or concentrate; adding sulfuric acid to the magnesium sulfate solution to salt out the magnesium sulfate as magnesium sulfate hydrate crystals in a salting process, and partially diluting the sulfuric acid; recycling the diluted sulfuric acid for use in the process of leaching the metal containing ore or concentrate; and recovering the solid magnesium sulfate crystals.

This application is a continuation of and claims priority from PCT/AU2006/001984 published in English on Jun. 28, 2007 as WO 2007/070974 and from AU 2005907249 filed Dec. 22, 2005, the entire contents of each are incorporated herein by reference.

### FIELD OF THE INVENTION

The present invention relates to a process for the recovery of solid magnesium sulfate hydrate. It is particularly applicable to the recovery of a crystallised solid magnesium sulfate hydrate product from a solution containing magnesium sulfate.

The process is particularly applicable to the recovery of solid magnesium sulfate hydrate, by the treatment of a magnesium sulfate solution recovered from a brine solution that has been produced during a process for the recovery of metal from a metal bearing ore or concentrate. It has particular application to the treatment of magnesium sulfate recovered from a brine solution associated with a nickel and cobalt recovery process that utilises sulfuric acid to leach nickel and cobalt from nickel and cobalt containing ores. The process utilises concentrated sulfuric acid to salt out solid magnesium sulfate as crystals from a solution containing solubilised magnesium sulfate, and recovering the solid magnesium sulfate as hydrate crystals.

The solid magnesium sulfate hydrate crystals may then be substantially dehydrated to a solid product that is useful in a process for recovery of magnesium oxide by converting the substantially dehydrated solid magnesium sulfate to magnesium oxide. The magnesium oxide can in turn be used as a neutralising agent in a metal recovery process such as a nickel and cobalt removing process.

### BACKGROUND OF THE INVENTION

Magnesium oxide, or magnesia, is used relatively extensively in the mining industry, for example in hydrometallurgical refining processes for metal recovery. One particular use for magnesium oxide is a neutralising agent to control the pH of acidic solutions. In nickel recovery processes, it is used to raise the pH of an acidic solution containing dissolved nickel and cobalt ions, to precipitate nickel and cobalt from acidic solutions as nickel and cobalt hydroxides.

One application of such a process is included within the Cawse project in Western Australia that recovers nickel and cobalt from laterite ores. The Cawse process, which is disclosed by White in AU701829 utilises solid magnesium oxide or freshly slurried magnesium oxide to precipitate dissolved nickel and cobalt from acidic solutions obtained from pressure acid leaching of laterite ores. The BHP Billiton Ravensthorpe project also proposes to recover nickel and cobalt as a mixed nickel and cobalt hydroxide product, as described by Miller et al, “Observations From the RNO Pilot Plant at Lakefield Research 2000 AD”, presented at ALTA 2001 Ni/Co-7 Conference, Scarborough, 15-18 May 2001.

Generally, good quality reactive magnesium oxide is not widely available and needs to be imported into a nickel refinery process, as is done in the Cawse project. This can add considerably to the cost of the nickel recovery process.

Laterite ores include both a high magnesium content saprolite component, and a low magnesium content limonite component. In commercial processes such as the Cawse process, nickel and cobalt are recovered from laterite ore by high-pressure acid leach processes where the nickel and cobalt are leached from the ore with sulfuric acid and precipitated as a mixed hydroxide following the addition of magnesium oxide.

Other non-commercial processes have been described where a mixed hydroxide precipitate is produced following the addition of a neutralising agent in an atmospheric pressure acid leach, or a combination of high pressure and atmospheric pressure leach process, or a heap leaching of the laterite ores. An example of such a process is disclosed by Liu in WO03/093517 and related specifications.

During such nickel recovery processes, magnesium values contained in the saprolitic silicates of nickel containing laterite ores are generally discarded as waste. The magnesium solubilised from the magnesium oxide used in the process is also discarded as waste. The dissolved magnesium generally reports to brine ponds associated with the refinery as magnesium sulfate or magnesium chloride brine.

The brine pond material is generally regarded as a waste product of the process. Metal values in the rejects material are lost when discarded as tailings and may also cause environmental concerns.

One feature of many nickel laterite acid leach processes is the on site production of sulfuric acid from elemental sulfur using an acid plant. Typically, an acid plant provides byproduct heat, in the form of steam, and sulfuric acid of concentration 98% w/w. The use of 98% sulfuric acid and steam to operate high pressure acid leach (HPAL) autoclaves means that both products are committed to the nickel leaching process. However heap and atmospheric leach processes, which operate at lower temperatures than HPAL, do not need the heat of dilution of the acid or the latent heat of the byproduct steam to maintain operating temperature. Dilute acid streams can be used for leaching nickel laterite ores in heap and atmospheric leaching without detriment to the process.

Thus a process which usefully uses the concentrated sulfuric acid from an acid plant, while delivering it in dilute form to an atmospheric or heap leach, would have an economic advantage.

The present invention aims to provide a new process where the magnesium that may be present in a by-product brine is recovered as solid magnesium sulfate hydrate. The solid magnesium sulfate hydrate can then be used in other processes, for example in the production of good quality magnesium oxide which in turn, can be used as a neutralising agent in a nickel and cobalt recovery process.

The present invention aims to overcome or at least alleviate one or more of the problems associated with the need to dispose of potentially useful magnesium to brine ponds or other potentially costly control methods during metal recovery processes.

The present invention further aims to provide an economic source of solid magnesium sulfate, which is useful for the production of good quality magnesium oxide for use in metal recovery processes.

The above discussion of prior processes is included in the specification solely for the purpose of providing a context for the present invention. It is not suggested or represented that these processes formed part of the prior art base or the common general knowledge in the field relevant to the present invention before the priority date.

### SUMMARY OF THE INVENTION

The present invention relates to a process for the recovery of solid magnesium sulfate hydrate in a crystalline form from a source that contains magnesium sulfate in solution. Generally the source of magnesium sulfate is the discarded solution in a process to recover metal from a metal bearing ore, or concentrate, but the process is particularly applicable to the treatment of discarded solution in a nickel and cobalt recovery process, where sulfuric acid has been used to leach nickel and cobalt containing ores. In the process of the invention, solid magnesium sulfate hydrate crystals are recovered by salting out the solid crystals from a solution containing magnesium sulfate by the addition of concentrated sulfuric acid.

The process of the present invention is particularly applicable to treatment of brine which results from a nickel and cobalt processing refinery, wherein the brine includes dissolved magnesium sulfate. The applicants have found that the magnesium sulfate can be recovered as useful solid magnesium sulfate hydrate by treating the solution with sulfuric acid to recover a crystallised solid form of magnesium sulfate hydrate. The solid magnesium sulfate hydrate may then be dehydrated by the addition of further concentrated sulfuric acid to produce a solid magnesium sulfate product.

Accordingly, the present invention resides in a process for recovering solid magnesium sulfate hydrate from a source of magnesium sulfate in solution said process including the steps of:
(a) providing a source of magnesium sulfate in solution that is derived from part of a process associated with the leaching of a metal containing ore or concentrate;
(b) adding sulfuric acid to the magnesium sulfate solution to salt out the magnesium sulfate as magnesium sulfate hydrate crystals in a salting process, and partially diluting the sulfuric acid; and
(c) recycling the diluted sulfuric acid for use in the process of leaching the metal containing ore or concentrate; and
(d) recovering the solid magnesium sulfate crystals.

It is most preferred that the source of magnesium sulfate in solution is derived from part of a nickel and cobalt recovery process that utilises acid to leach nickel and cobalt containing ores, most preferably the process is applicable to the use of sulfuric acid to leach nickel and cobalt containing ore.

Whereas the invention is particularly applicable to a process that utilises sulfuric acid to leach nickel and cobalt containing laterite ores, in particular the leaching of the high magnesium content saprolite component of laterite ores, it may also be applicable to other leaching processes such as the oxidative acid leaching of nickel containing sulfide ores or concentrates, or processes that involve the ammoniacal leaching of laterite ores or combined ammoniacal/acid leaching of ores. In each of these processes, there is generally a quantity of magnesium sulfate that may report to the waste ponds, due to the inherent content of magnesium and sulfur within the ore, or magnesium and sulfur that is introduced during the leach process.

### BRIEF DESCRIPTION OF THE DRAWINGS

FIG. 1 illustrates a process for producing substantially anhydrous magnesium sulfate from magnesium sulfate in solution.

### DESCRIPTION

In a preferred embodiment, the source of magnesium sulfate is a brine that is associated with a nickel and cobalt recovery refinery, where the nickel and cobalt ore is subjected to a sulfuric acid leach process, and it will be convenient to describe the invention in relation to such a process. Generally, in such processes the nickel and cobalt recovery will include one or more steps where one or more of iron, aluminium, nickel, cobalt and manganese are precipitated, generally as hydroxides by adding a neutralising agent such as a magnesium containing alkali to a pregnant leach solution containing such species. Preferably, the magnesium containing alkali will be selected from magnesium oxide, magnesium hydroxide, magnesium carbonate or dolomite. In such a precipitation process, the magnesium would generally dissolve and report as a solution of magnesium sulfate and is discarded as a by-product brine.

In another source of magnesium, the nickel and cobalt containing ores generally would include significant quantities of magnesium, particularly from the magnesium minerals such as serpentine associated with the saprolitic components of laterite ore or saprock. This magnesium content is generally leached together with the desired nickel and cobalt ions with the sulfuric acid, but is discarded as magnesium sulfate in the brine.

The solid magnesium sulfate hydrate may then be recovered from the discarded magnesium sulfate in solution that is contained within the byproduct brine associated with a nickel and cobalt recovery refinery.

The nickel and cobalt recovery process is preferably either a pressure acid leach, an atmospheric pressure leach, an ammoniacal leach or a heap leach process. Most preferably the process is applicable to processing laterite ore under atmospheric pressure or heap leach conditions, however it should be understood that the processing of other metals containing ores is contemplated within the invention where the process results in the production of at least some magnesium sulfate in solution.

In a preferred form, the nickel and cobalt recovery process is a heap leach process where sulfuric acid is allowed to percolate through one or more heaps of laterite ore to produce a leach liquor. The leach liquor is generally recycled through the one or more heaps to build up the levels of both the desired nickel and cobalt and also the levels of magnesium in the resultant leach liquor. Preferably the level of magnesium in the resultant leach liquor is built to a level of greater than 20 g/L, preferably greater than 40 g/L, to make it feasible to then produce solid magnesium sulfate hydrate crystals.

The nickel and cobalt recovery process may also be an atmospheric leach process where sulfuric acid is used to leach laterite ore to produce leach liquor. Again, the leach liquor may be recycled to the atmospheric leach process to build up the levels of magnesium together with the nickel and cobalt in the resultant leach liquor.

Sulfuric acid may then be added to the magnesium sulfate containing brine to salt out the magnesium sulfate. Preferably, the concentration of the sulfuric acid used in the salting process is in excess of 100 g/L, more preferably greater than 200 g/L. Cooling of the solution may be used to assist with the recovery of magnesium sulfate hydrate crystals, and to increase the yield.

A soluble organic reagent may also be added to the magnesium sulfate solution to lower the solubility of the magnesium sulfate salt, therefore enabling lower concentrations of sulfuric acid to be used in the salting process. The soluble organic reagent will remain in the brine following the salting process and may be recovered from the brine by distillation, and recycled for use in the salting process. Preferably, the soluble organic reagent is methanol, ethanol, acetone or a mixture thereof.

The solution containing the magnesium sulfate may be cooled after the addition of the concentrated sulfuric acid to assist in crystallisation of the solid magnesium sulfate hydrate, and to increase the yield if required. The temperature at which the salting out process is carried out may be any temperature from the ambient temperature to the freezing point of the solution. The magnesium sulfate crystals are recovered as solid magnesium sulfate hydrate.

A further step may then be carried out, by which concentrated sulfuric acid is used in a dehydration step to dehydrate the crystallised magnesium sulfate hydrate to produce substantially dehydrated magnesium sulfate crystals and a residual diluted sulfuric acid. The concentrated sulfuric acid should preferably be at least 80% sulfuric acid. More preferably the concentrated sulfuric acid should be the commonly produced 98% sulfuric acid of commerce. The dehydration process results in a diluted acid stream and dehydrated magnesium sulfate crystals. The residual diluted sulfuric acid may then either be recycled to either the nickel and cobalt recovery process, or may be reused in the salting process. The sulfuric acid used in the salting process may also be recycled to the nickel and cobalt recovery process.

The concentrated sulfuric acid for the dehydration step may be provided by diverting the acid that is to be used in the nickel and cobalt leaching step. Whereas the sulfuric acid may be diluted to some extent following the dehydration step, it will still be of sufficient strength to be suitable in the nickel and cobalt leach step, or in the salting out of magnesium sulfate hydrate crystals. Therefore, the partially diluted sulfuric acid is preferably recycled to the leach step, particularly an atmospheric or heap leach step, or the salting out step, following the dehydration of the magnesium sulfate product. The substantially dehydrated magnesium sulfate crystals are particularly useful for use in a process in the production of magnesium oxide. The solid magnesium sulfate may be calcined to produce magnesium oxide, which may be useful for use as a neutralising agent in the nickel and cobalt recovery process. Such a process is disclosed by Aman in British patent GB793700. More preferably the solid magnesium sulfate may be calcined in a reducing atmosphere to produce reactive MgO and sulfur dioxide gas, which may be converted to sulfuric acid using an acid plant.

It is a particular benefit of the present invention that a commercially useful product is recovered from a source of magnesium that would otherwise be at best simply discarded as a waste product.

It is a further particular advantage that any sulfuric acid used in the process can readily be obtained from other steps in the nickel and cobalt recovery process, and recycled to that step. Therefore, there is substantially no net consumption of sulfuric acid in the magnesium sulfate recovery process, as any acid used is readily recycled for use in its original purpose of leaching nickel and cobalt from laterite ore.

It is yet a further advantage, in that by converting the solubilised magnesium sulfate to a solid product, the solid product may usefully be used for the production of other products for use in a nickel and cobalt recovery process, thereby alleviating some environmental concerns that could result by simply discarding the magnesium sulfate as waste product.

In an additional advantage water is recovered from the brine, by the removal from solution of magnesium sulfate, which otherwise would prevent return of the water to the leaching steps, with addition of make up sulfuric acid from the acid plant. In absence of this advantage, water would be required to be supplied to the process, and water would be rejected and lost with the brine.

The invention will be described with reference to the accompanying drawings, however, it should be appreciated that the drawings are illustrative of preferred embodiments of the invention and the invention is not intended to be limited thereto.

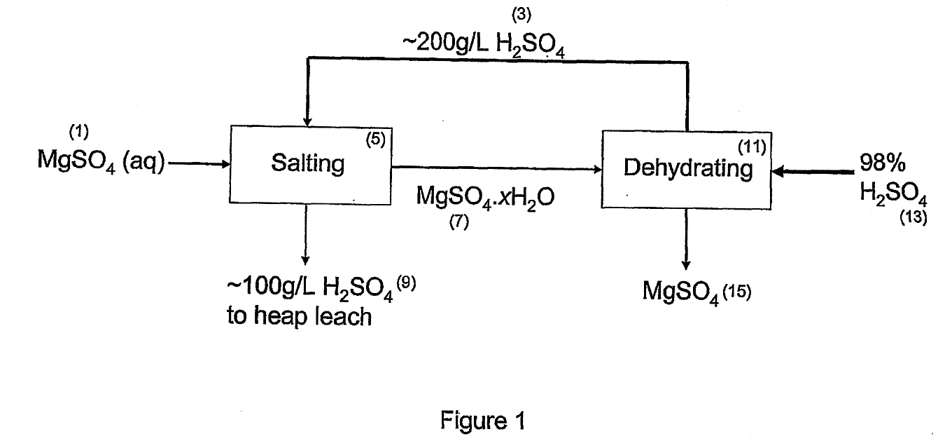

In FIG. 1, aqueous magnesium sulfate (1) is provided from a brine solution that has been rejected as a waste product from a nickel and cobalt recovery process. Concentrated sulfuric acid (3) is added to the magnesium in solution in a salting process (5), to give an acid concentration of at least 100 g/L, more preferably 200 g/L as H₂SO₄. This salting process produces a solid magnesium sulfate hydrate in crystalline form (7). The solution may be cooled to assist with the crystallisation, and to increase the yield. The crystals may be separated by conventional means known by those familiar with the art, such as settling, filtration or centrifuging. The sulfuric acid may be recovered from the salting process in a partially diluted form, having a concentration of approximately 100-200 g/L (9). This partially diluted sulfuric acid may be recycled to the leach step in the nickel and cobalt recovery process either directly, or with further dilution if desired.

The solid magnesium sulfate hydrate crystals (7) then undergoes a dehydrating step (11) by adding 98% sulfuric acid (13). The concentrated sulfuric acid used in the dehydrating step may be recovered and used in the salting step (5).

Generally, the 98% sulfuric acid used in the dehydrating step has either been diverted from the heap leach or atmospheric leaching of the nickel and cobalt containing ores. There is therefore, substantially no net loss of sulfuric acid as it can readily be recovered and used in the leaching process following salting and dehydration of the magnesium sulfate crystals.

Following the dehydrating step (11) a substantially dehydrated magnesium sulfate product (15) is produced, and separated from the diluted acid by conventional means such as filtration or centrifuging. This solid magnesium sulfate product can then be used in a process for producing magnesium oxide, which can then be used in the nickel and cobalt recovery process as a neutralising agent.

### EXAMPLES 1-4

A stock solution containing 40 g/L of Mg as magnesium sulfate was made up. To four different beakers, this solution and 98% sulfuric acid were added as indicated in the table below to give solutions with total volume 250 ml containing, nominally 100, 200, 300 and 400 g/L of acid respectively.

| | Nominal | | | |
|---|---|---|---|---|
| Example | Concentration | ml 98% | ml 40 g/L | Total Vol |
| Number | g/L | H₂SO4 | Mg | (ml) |
| 1 | 400 | 56.7 | 193.3 | 250.0 |
| 2 | 300 | 42.5 | 207.5 | 250.0 |
| 3 | 200 | 28.3 | 221.7 | 250.0 |
| 4 | 100 | 14.2 | 235.8 | 250.0 |

The solutions were then cooled to −2° C. and kept at this temperature for about 30 hours. The crystals formed were separated from solution by filtration, allowed to dry in air and weighed to determine the yield of hydrated MgSO₄. The yields obtained from each of the solutions is shown below:

| Example | g MgSO₄ | % | | |
|---|---|---|---|---|
| Number | Obtained | precipitation | % Mg | % S |
| 1 | 37.3 | 47.6 | 10.0 | 13.3 |
| 2 | 44.9 | 53.3 | 11.1 | 14.6 |
| 3 | 29.3 | 32.5 | 10.4 | 13.8 |
| 4 | 12.7 | 13.3 | 10.1 | 13.6 |

The XRF analyses of the crystals show that the composition of the MgSO₄ hydrate is MgSO₄.xH₂O where x is in the range of 5-7.

### EXAMPLE 5

Magnesium sulfate hydrate (20 g) prepared as described in Example 2 was contacted with 50 mL of 98% H₂SO₄ for 2 hours at 50° C. The crystals were then separated from the acid by filtration using glass fibre filtration media. The acid was diluted 20 fold and 5 mL was titrated against 1 M NaOH, requiring 7.9 mL of titrant, which corresponds to an acidity of 1550 g/L in the filtrate.

The crystals were then washed with ethanol then allowed to stand at ambient temperature to evaporate excess ethanol. The resulting solid was then analysed by XRF and found to contain 14.3% Mg and 22.0% sulfur. This corresponds to the formula MgSO₄.xH₂O xH₂O where x=1.8 (after correcting for residual H₂SO₄ content).

### EXAMPLE 6

A magnesium sulfate solution (40 g/L magnesium) was mixed with ethanol and/or sulfuric acid with a total constant volume, according to the conditions outlined in the table below. The resulting solutions were refrigerated at −3° C. for a minimum of 40 hrs. After refrigeration the samples were filtered and the crystalline material present was washed with ethanol, allowed to dry and then weighed.

| | | | % Precipitation of |
|---|---|---|---|
| | Concentration of | Concentration of | Magnesium (as |
| Test | Ethanol (% v/v) | Sulfuric Acid (g/L) | MgSO₄•7H₂O) |
| 1 | 0 | 200 | 25.6 |
| 2 | 5 | 200 | 26.7 |
| 3 | 15 | 200 | 36.1 |
| 4 | 30 | 200 | 57.5 |
| 5 | 15 | 0 | 25.2 |
| 6 | 30 | 0 | 70.1 |

Increasing concentrations of ethanol result in increasing magnesium precipitation. This occurs in both the presence and absence of sulfuric acid.

### EXAMPLE 7

A magnesium sulfate solution (40 g/L magnesium) was mixed with acetone and/or sulfuric acid with a total constant volume, according to the conditions outlined in the table below. The resulting solutions were refrigerated at −3° C. for a minimum of 40 hrs. After refrigeration the samples were filtered and the crystalline material present was washed with ethanol, allowed to dry and then weighed.

| | | | % Precipitation of |
|---|---|---|---|
| | Concentration of | Concentration of | Magnesium (as |
| Test | Acetone (% v/v) | Sulfuric Acid (g/L) | MgSO₄•7H₂O) |
| 1 | 0 | 200 | 36.7 |
| 2 | 5 | 200 | 34.1 |
| 3 | 15 | 200 | 41.2 |
| 4 | 30 | 200 | 47.3 |
| 5 | 30 | 0 | 52.5 |

The precipitation of magnesium in the presence of acetone occurs in both the presence and absence of sulfuric acid, however higher concentrations of acetone are required to cause precipitation in the absence of sulfuric acid.

The above descriptions are illustrative of the ambit of the invention with reference to the preferred embodiment. Variation without departing from the spirit or ambit of the invention should be considered to also form part of the invention described herein.

1. A process for recovering solid magnesium sulfate hydrate from a source of magnesium sulfate in solution said process including the steps of:
(a) providing a source of magnesium sulfate in solution that is derived from part of a process associated with the leaching of a metal containing ore or concentrate;
(b) adding sulfuric acid to the magnesium sulfate solution to salt out the magnesium sulfate as magnesium sulfate hydrate crystals in a salting process, and partially diluting the sulfuric acid;
(c) recycling the diluted sulfuric acid for use in the process of leaching the metal containing ore or concentrate; and
(d) recovering the solid magnesium sulfate crystals.

2. A process according to claim 1 wherein the source of the magnesium sulfate in solution is derived from a nickel and cobalt recovery process.

3. A process according to claim 2 wherein the source of magnesium sulfate in solution is a brine solution.

4. A process according to claim 3 wherein the brine solution is produced as part of a nickel and cobalt recovery process that includes the step of leaching magnesium containing minerals within the nickel and cobalt containing ore with sulfuric acid.

5. A process according to claim 4 wherein the nickel and cobalt recovery process includes one or more steps of precipitation of iron, aluminium, nickel, cobalt and manganese by adding a magnesium containing alkali to provide a solution containing magnesium sulfate as a byproduct.

6. A process according to claim 5 wherein the magnesium containing alkali is selected from magnesium oxide, magnesium hydroxide, magnesium carbonate or dolomite.

7. A process according to claim 4 wherein the nickel and cobalt recovery process is a heap leach process where sulfuric acid is allowed to percolate through one or more heaps of laterite ore to produce a leach liquor, wherein the leach liquor is recycled through the one or more heaps to build up the levels of magnesium in the resultant leach liquor.

8. A process according to claim 4 wherein the nickel and cobalt recovery process is an atmospheric leach process where sulfuric acid is used to leach a laterite ore to produce leach liquor, wherein the leach liquor is recycled to the atmospheric leach process to build up the level of magnesium in the resultant leach liquor.

9. A process according to claim 7 wherein the magnesium in the resultant leach liquor is at a level of greater than about 20 g/L.

10. A process according to claim 1 wherein the concentration of the acid used in the salting process is in excess of about 100 g/L.

11. A process according to claim 1 wherein the solution containing magnesium sulfate is cooled after the addition of the concentrated sulfuric acid solution to assist in crystallisation of the solid magnesium sulfate hydrate.

12. A process according to claim 1 wherein a soluble organic reagent is also added to the magnesium sulfate solution to lower the solubility of the magnesium sulfate salt therefore enabling lower concentrations of sulfuric acid to be used in the salting process.

13. A process according to claim 12 whereas the soluble organic reagent remains in a brine following the salting process.

14. A process according to claim 13 wherein the soluble organic reagent is recovered from the brine by distillation, and is recycled for use in the salting process.

15. A process according to claim 12 wherein the soluble organic reagent is methanol, ethanol, acetone or a mixture thereof.

16. A process according to claim 1 wherein the magnesium sulfate crystals are recovered as solid magnesium sulfate hydrate.

17. A process according to claim 16 wherein concentrated sulfuric acid is used in a dehydration step to dehydrate the crystallised magnesium sulfate hydrate to produce substantially dehydrated magnesium sulfate crystals and residual partially diluted sulfuric acid.

18. A process according to claim 17 wherein the residual partially diluted sulfuric acid is recycled to either the process of leaching the metal containing ore or concentrate, and/or the salting process.

19. A process according to claim 1 wherein the sulfuric acid solution remaining after partial or complete salting out of the magnesium sulfate is recycled for use in the process of leaching the metal containing ore or concentrate.

20. A process according to claim 17 where the substantially dehydrated magnesium sulfate is reduced to a magnesium oxide product.
